(19) United States
(12) Patent Application Publication
(10) Pub. No.: US 2002/0158884 A1
(43) Pub. Date: Oct. 31, 2002

(54) System and method for displaying and printing images according to selected sizes

(76) Inventors: Manuel Gonzalez, Barcelona (ES); Luca Chiarabini, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/843,885

(22) Filed: Apr. 30, 2001

(51) Int. Cl. G09G 5/02

(52) U.S. Cl. 345/593

(57) ABSTRACT

A system and method for displaying an image configured to be printed on a print medium in its selected size. According to one aspect, a terminal displays a plurality of images from which a user may select to view at least one of the images to be printed. The terminal is operable to enable the user to select specific characteristics of the image as well as the mounting background upon which the image is to be positioned. A display device is attached to the terminal to display the selected image along with their selected characteristics according to their selected attributes (e.g., sizes and colors). A printed version of the selected image may be printed according to the selected attributes of the selected image substantially immediately following the selection of the image and its attributes.

### FIELD OF THE INVENTION

This invention relates generally to a system and method for displaying images according to selected sizes. More specifically, the invention relates to a system and method for displaying images according to their selected dimensions, such that the selected images, frames, mounting surfaces, etc., may be displayed as they would appear prior to printing of the selected images.

### DESCRIPTION OF RELATED ART

Various types of printed media, e.g., posters, depicting various types of images, e.g., works of art, nature scenes, photographs, etc., are sold by vendors throughout the world. Due to space constraints as well as individual acumen, these types of printed media are generally offered for sale in specific sizes, and in certain instances, with specific frames. In this regard, if a frame has been installed on a printed medium prior to its viewing by a consumer, and the consumer desires to place a different frame around the printed medium, the frame must be replaced. If a frame has not been installed on a printed medium, and the consumer desires to view the printed medium with a plurality of different frames, the consumer would have to position various frames on top of the printed medium to see exactly how the printed medium and the frame will appear together. The above-described solutions to enable a consumer to view a printed medium and frame together prior to assembly may indeed be quite tenuous.

With the advent of the Internet and the use of computers to view both printed media and various frames prior to purchase, consumers are now able to view how the posters and frames appear together prior to purchase thereof. In this respect, devices (e.g., computers that display a variety of images from which a consumer may select to purchase any number of printed media) are generally available to allow consumers to browse through an image gallery to thereby select one or more images and order printed media based upon their selections. In these types of devices, a consumer may generally have certain options when selecting to purchase a printed medium.

FIG. 1 illustrates a flow chart 100 depicting a conventional method of displaying a plurality of images prior to a user, e.g., consumer, purchasing printed versions of the images, i.e., posters. As seen in FIG. 1, the method generally includes a program which runs a plurality of steps to assist a user in purchasing printed versions of displayed images. At the outset, the program begins by displaying a main page 110 on, for example, a screen, to attract potential customers and to provide a portal through which the user's client status may be identified, as seen at step 112. If the user is identified as an existing client, the user may log into an existing account at step 114. The user typically logs into an account by providing certain information unique to that user, e.g., user identification number and password. If the user is identified as a new client, the user may be requested to set up a new account at step 116, e.g., select a desired user identification name, password, and possibly credit-card information, to gain further access to the program.

At step 118, after the user has gained further access to the program, the program typically displays a variety of images. The displayed images may be reduced representatives of the selection of images (e.g., thumbnails), such that a plurality of images may be displayed on a single screen. However, the displayed images may be sorted according to the image name, filename, genre, artist, or the like. Furthermore, the displayed images may be stored in subdirectories according to various categories of images. In any event, the program generally enables the user to view any of the displayed images in a larger size and thus in greater detail. If the user does not select any of the displayed images, the user may either log out or may view another set of images. The above described process then continues until the user selects a desired image or logs out of the program. If the user logs out, the program typically reverts back to displaying the main page at step 110, such that the above-described process may be repeated.

Typically, after the user has selected any of the displayed images at step 120, the program allows the user to alter the attributes of the selected image at step 122. In this regard, the program may display a paper attribute screen shot 130 (FIG. 2A) that allows the user to select certain attributes of the selected image. As illustrated in FIG. 2A, the paper attribute screen shot 130 may be configured to present a user with at least one pre-determined poster size. Each pre-determined poster size may be represented by an icon with a symbol differentiating the pre-determined sizes from one another.

Additionally, a custom size option may also be presented as an icon in the paper attribute screen shot 130. If the custom size option is invoked, as illustrated in FIG. 2B, the paper attribute screen shot 130 may be enable a user to input possible sizes for the selected image. The paper attribute screen shot 130 may be additionally configured to verify if the inputted dimension conforms to the correct ratio of the selected image. If not verified, the paper attribute screen shot 130 may be further configured to request the user input another dimension for the output image, until a valid ratio is selected.

As illustrated in FIG. 2C, the paper attribute screen shot 130 may be further configured to present the user with at least one type of medium upon which the image is to be printed.

As illustrated in FIG. 3, the program may also include a poster attribute screen shot 140 which may be configured to request a frame style and color, as well as matte color and size. The frame style and color, and matte color and size may be selected via drop-down menus providing the user with a plurality of options from which to select. After the user has selected the various attributes for the poster, the user may be provided with an option to view the poster along with the selected attributes. If the user selects to view the poster, the program may display the selected poster along with its attributes on a screen.

After the user has selected a poster along with its desired attributes, the user may add the poster to a “shopping cart” or otherwise select to have the image printed on a selected print medium for purchase at step 124. The user may then be prompted as to whether the user is interested in selecting any additional posters at step 126. If the user elects to view any additional posters, the user may be shown additional poster images at step 118. If the user elects not to select any additional posters, the user is then prompted to checkout at step 128. During the checkout step 128, the user typically confirms the purchase, inputs billing and shipping information, and is typically provided with a confirmation receipt.

Although the conventional method illustrated in FIG. 1 generally allows a user to view a poster image on a screen prior to purchase of a printed version of the image, i.e., poster, and in certain circumstances allows the user to view the image along with a selected frame, the conventional method suffers from a variety of drawbacks and disadvantages. For instance, the conventional method does not allow a user to view a poster in its actual size. Moreover, the conventional method does not enable a user to visually determine whether the poster color and the frame will match the color of the room and/or the wall upon which the poster is to be installed. In addition, the conventional method does not enable a user to visually determine whether the poster dimensions are adequate and will aesthetically match with the surroundings where the poster is to be installed.

### SUMMARY OF THE INVENTION

In contrast to known systems for vending posters, the present invention does not suffer from the drawbacks and disadvantages associated with these types of systems.

According to one aspect, the present invention pertains to a system for displaying an image at its selected size, in which the selected image size is configured to be printed by a large format printer. The system includes a terminal for displaying a plurality of images and an image program to enable the display of at least one of the images. The image program is configured to enable the selection of a plurality of attributes of the image such that the selection of the plurality of attributes includes at least one option for selecting the dimensions for the image. The system also includes a display device for displaying the selected image according to the selected dimensions on a viewing surface.

According to another aspect, the present invention pertains to a method for displaying an image at its selected size and printing the image. According to the method, at least one selectable image is displayed on a terminal. Additionally, a plurality of attribute options for the at least one selectable image is displayed on the terminal, including the dimensions of the image. The selected image is displayed according to its selected dimensions on a viewing surface and the selected image is printed on a print medium having at least an A3 size by a large format printer.

According to yet another aspect, the present invention relates to a business method for supplying printed versions of selected images. According to the method, a customer is supplied with a plurality of images to choose from. The customer is also supplied with a plurality of attribute options for any selected image, including the size of the selected image. The chosen image is displayed with the selected attributes, and the chosen image is printed according to its selected dimensions.

Certain aspects of the present invention afford certain advantages over known poster vending systems. For example, according to the principles of the present invention, images are displayed at their selected dimensions, with their selected frames and mattes, the selected background color and dimensions of the mounting surface upon which the printed versions of the selected images are to be installed, as well as the position of the printed versions on the mounting surface. These advantages of certain aspects of the present invention are especially evident when the selected image is relatively large and is to be printed by a large format printer.

### BRIEF DESCRIPTION OF THE DRAWINGS

Features and advantages of the present invention will become apparent to those skilled in the art from the following description with reference to the drawings, in which:

FIG. 1 illustrates a flow chart depicting a conventional manner in which a consumer may select and purchase posters from a device which displays poster images;

FIGS. 2A-2C are exemplary screen shots of a conventional manner in which a paper attribute module may display and receive information pertaining to a desired poster;

FIG. 3 is an exemplary screen shot of a conventional manner in which a poster attribute module may display and receive information pertaining to a desired frame and matte for placement on a poster;

FIG. 4 is a generally simplified illustration of a system possessing a plurality of components to enable a user to view selected images in their actual sizes in accordance with the principles of the present invention;

FIG. 5 illustrates a flow chart depicting a manner which a user may select and purchase posters from a variety of posters in accordance with the principles of the present invention; and

FIG. 6 is an exemplary screen shot of a preview module that displays and receives information pertaining to a mounting background for a poster in accordance with the principles of the present invention.

### DETAILED DESCRIPTION OF THE INVENTION

For simplicity and illustrative purposes, the principles of the present invention are described by referring mainly to an exemplary embodiment of the present invention, particularly with references to an example of a computer system and a display device for displaying images according to their selected sizes. However, one of ordinary skill in the art would readily recognize that the same principles are equally applicable to, and can be implemented in, any device that enables a user to select to view images in their selected sizes, and that any such variation would be within such modifications that do not depart from the true spirit and scope of the present invention.

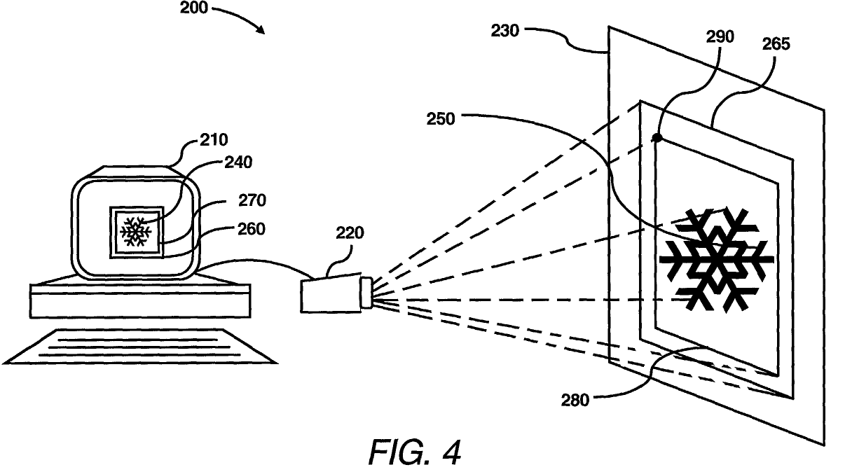

Generally illustrated in FIG. 4 is a representative system 200 for enabling a selected image to be displayed at its selected size. As seen in FIG. 4, the system 200 includes a terminal 210, e.g., a computer system, through which a plurality of images may be displayed. The system 200 also includes a display device 220 and a viewing surface 230, e.g., a screen, wall, or the like, upon which the selected image may be displayed. Although the display device 220 in FIG. 4 is illustrated as a projection device, it is within the purview of the present invention that selected images may be displayed by any known reasonably suitable displaying devices, e.g., relatively large screens having an integrated projector, computer displays, etc.

According to an aspect of the present invention, all of the components of the system 200 may be situated in a self-contained unit which may be transported and positioned in various places, e.g., a store, museum, concert, or the like.

In further reference to FIG. 4, it is seen that a selected image 240 may be viewed on the terminal 210. The terminal 210 is also configured to control the display device 220 to display an image of the selected image in its selected size 250. In this respect, the terminal 210 may contain an algorithm operable to determine the required size of the image display 250 based upon desired dimensions of the image to be projected. In one respect, the distance between the projector 220 and the viewing surface 230 may be inputted into the algorithm to thus enable the algorithm to calculate and display an image according to its selected size.

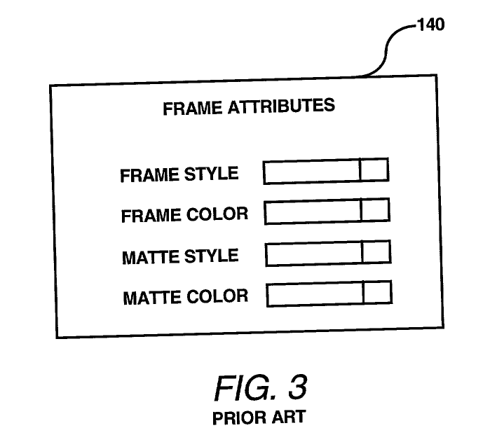

According to a preferred embodiment of the present invention, along with displaying the selected size of the image 250, the system 200 may be configured to display various attributes of the image and frame, as well as attributes of the mounting surface. For example, a frame and matting 270 to be placed around the selected image may also be selected. Should the frame and matting 270 around the selected image be selected, the display device 220 is operable to display the selected frame and matting according to their selected attributes 280 (e.g., frame style and color, matting color and size, etc. (refer to FIG. 3)). Thus, the selected image may be displayed at its selected size 250 and with a frame and matting 280 also in their selected sizes. In this respect, the appropriateness of the image 250 and the frame and/or matting 280 may be relatively accurately determined prior to physical production of a poster of the image as well as the frame and matting.

Furthermore, a mounting background having a specified color and dimensions 260 may also be selected and displayed. For example, the mounting background color may match the color of the structure upon which a printed version of the image (i.e., poster) is to be installed. Additionally, the dimensions of the mounting background may equal the dimensions of the structure upon which the printed version of the image is to be installed. In this case, the terminal 210 and display device 220 are operable to display the mounting background 265 in its selected size and color along with the selected image 250, frame, and matting 280. Thus, according to one aspect of the invention, the selected image 250 may be displayed in substantially accurate spatial relationship to a structure upon which a poster of the image is to be installed. Moreover, the appropriateness of the selected image 250, along with a selected frame and matting 270, may be relatively accurately determined for the color of the structure upon which the poster is to be installed prior to printing of a poster based upon the selected image.

In addition, an anchor point 290 of the selected image 250 and position of the anchor point on the structure may also be selected to display the selected image with respect to the dimensions of the structure upon which a poster of the selected image is to be installed. The anchor point 290 may be repositioned to various locations with respect to the mounting background 260 to thus relatively accurately determine the appearance of the poster of the image at various positions on the mounting background.

According to an aspect of the invention, the terminal 210 may possess software which is programmed with certain aesthetic guidelines configured to provide a user with certain suggestions regarding their selections for the images. In this respect, an icon or a plurality of icons (not shown) may be displayed in the vicinity of each selectable feature upon a display of the terminal 210. Upon selecting an icon, an aesthetic engine may be initiated, which supplies advice as to certain accepted aesthetic guidelines. For example, the aesthetic engine may analyze the selected features (e.g., wall color, poster color, frame color, etc.) to determine which colors are aesthetically acceptable for another feature (e.g., wall color, poster color, frame color, etc.). Additionally, the aesthetic engine may suggest certain images that may be suitable with a selected wall color. In this instance, an icon or a plurality of icons may be displayed in the vicinity of a background color selection module on the display screen. Moreover, the aesthetic engine may also suggest aesthetically suitable poster sizes to match selected wall sizes.

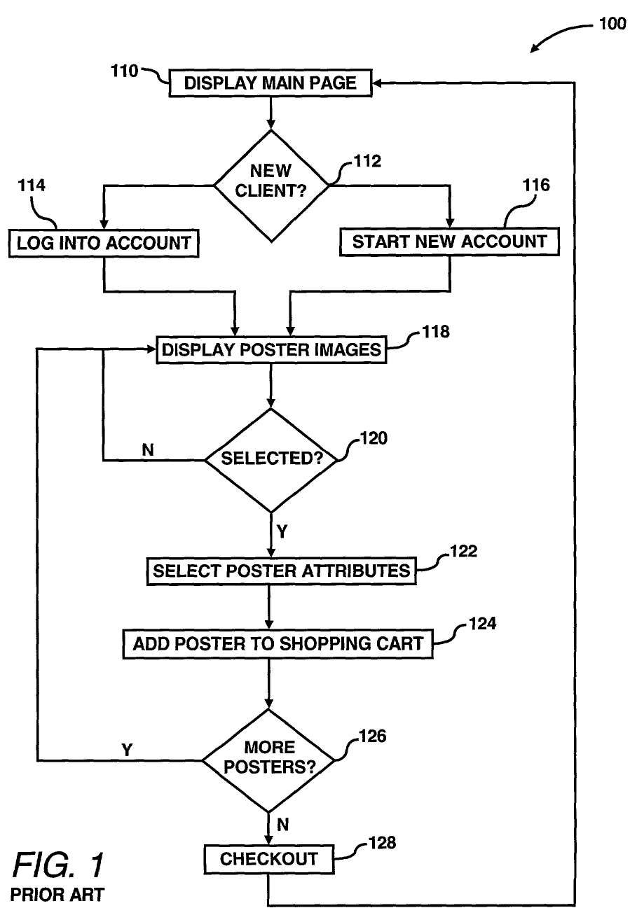

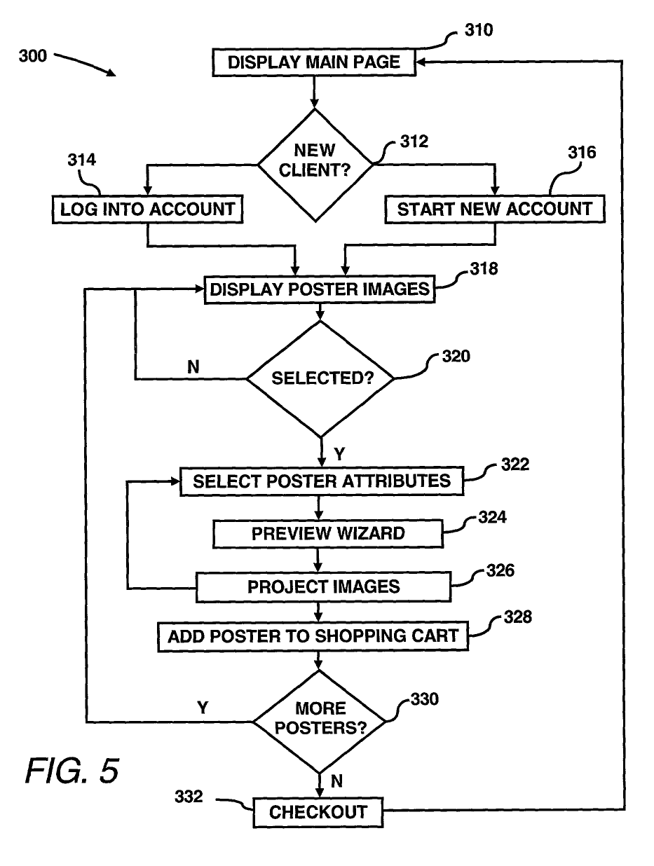

With reference to FIG. 5, a flowchart 300 is set forth by way of illustrative example and depicts a manner in which a user may select to purchase posters according to the principles of the present invention. In certain respects, steps 310-322, 330, and 332 are similar to the those described hereinabove with respect to the flowchart 100 illustrated in FIG. 1. Therefore, a detailed description of steps 310-322, 330 and 332 will not be set forth herein. Rather, in addition to certain references to certain of these steps set forth hereinbelow, the description recited above in regard to the flowchart 100 is relied upon as being generally sufficient to enable one of ordinary skill in the art to make and/or use the present invention with respect to those steps.

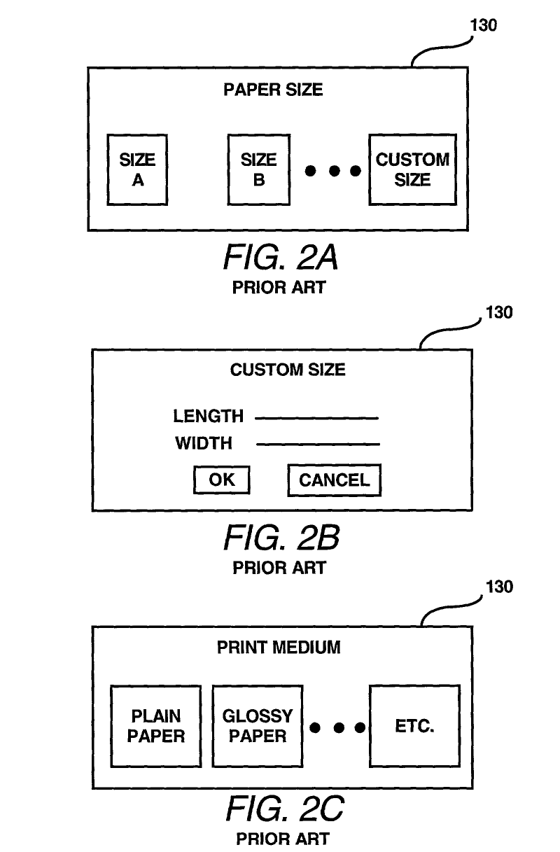

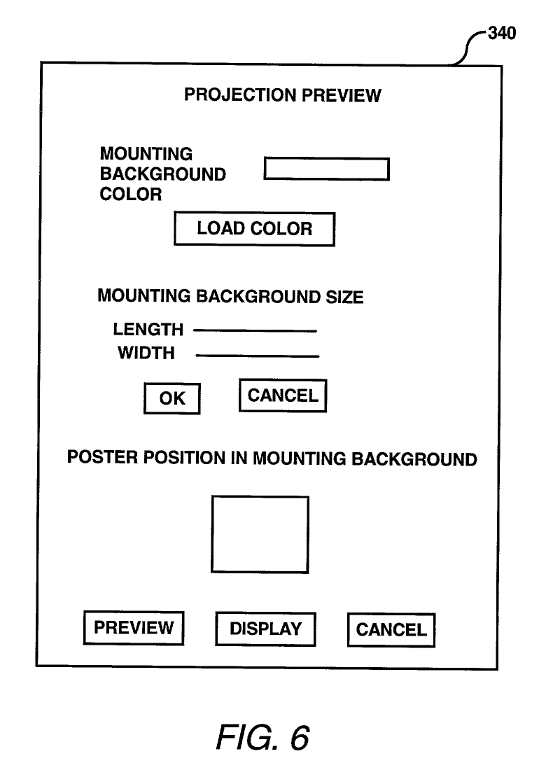

Beginning with step 324 in FIG. 5, after the poster attributes have been selected (see FIGS. 2A-2C), a preview wizard is displayed to enable the selection of certain features of a mounting surface upon which the poster is to be hung. As illustrated in FIG. 6, an exemplary preview screen shot 340 generally depicts a plurality of selectable criteria through which certain aspects of the mounting surface as well as the position of the poster with respect to the mounting surface may be varied. The preview screen shot 340 generally enables the selection of color and dimensions of the mounting surface and a placement of the poster on the mounting surface. Values may be selected for the color and size of the mounting surface and/or placement of the poster on the structure. A “Preview” button may be provided to enable the display of a reduced version of the image and the mounting surface on the terminal 210. Additionally, a “Display” button may be provided to display the image onto the viewing surface 230, as in step 326.

After viewing the displayed images, the attributes of the image may be further varied or a printed version of the selected images may be produced. If the attributes are varied, step 326 may be repeated. The process illustrated in FIG. 5 may be repeated any number of times until the customer either decides to logout or to add the selected image to a “shopping cart” for later printing and purchase. In the instance that the customer chooses to print the selected image, the selected image may be printed by a printer located in relative proximity to the image display system, such that the customer may receive a poster of the selected image relatively shortly after selecting an image.

According to the principles of the present invention, relatively large images may be displayed according to their selected dimensions prior to the printing of posters from the selected images. In this regard, images that are to be printed by a large format printer onto relatively a large print medium (e.g., A3 paper size and larger) may also be displayed in their selected dimensions. Thus, according to an aspect of the present invention, a relatively wide variety of images may be displayed in a relatively wide variety of dimensions prior to the printing of posters from the selected images.

What has been described and illustrated herein is a preferred embodiment of a system and a manner in which a user may view a poster and its mounting surface in their actual sizes and colors, along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A system for displaying an image at its selected size, wherein said selected image is configured for printing by a large format printer, said system comprising:
a terminal for displaying a plurality of images, said terminal including an image program for enabling the display of at least one of said images on said terminal, said image program being configured to enable the selection of a plurality of attributes of said image, wherein said selection of said plurality of attributes includes at least one option for selecting the dimensions for said image; and
a display device for displaying said selected image according to said selected dimensions, such that said image is displayed at its selected dimensions.

2. The system according to claim 1, further comprising:
a viewing surface upon which said selected image is operable to be displayed.

3. The system according to claim 2, wherein said viewing surface comprises a wall or a screen.

4. The system according to claim 1, wherein said terminal enables the selection of a mounting background for display with said selected image.

5. The system according to claim 4, wherein said terminal further enables the selection of color and dimensions for said mounting background and wherein said display device is operable to display a mounting background image according to said selected color and dimensions of said mounting background.

6. The system according to claim 4, wherein said terminal enables the selection of a mounting position for said selected image on said mounting background.

7. The system according to claim 6, wherein said display device is operable to display said selected image according to said selected mounting position with respect to said mounting background.

8. The system according to claim 1, wherein said terminal further comprises an aesthetic engine program for providing decorator information.

9. The system according to claim 1, further comprising a printer operable to produce a printed version of said selected image.

10. The system according to claim 9, wherein said printer is a large format printer operable to print said selected image on a print medium having at least an A3 size.

11. A method for displaying an image at its selected size and printing said image, said method comprising the steps of:
displaying at least one selectable image on a terminal;
displaying a plurality of attribute options for said at least one selectable image on said terminal, wherein one of said attribute options includes dimensions for said selected image;
displaying said selected image according to its selected dimensions on a viewing surface; and
printing said selected image on a print medium having at least an A3 size on a large format printer.

12. The method according to claim 11, wherein said attribute displaying step further comprises the steps of:
displaying frame options, wherein said frame options include a plurality of frames and frame dimensions; and
displaying said frame and said selected image in their selected dimensions on said viewing surface.

13. The method according to claim 12, wherein said attribute displaying step further comprises the steps of:
displaying matte options, wherein said matte options include a plurality of matte colors and matte dimensions, and wherein said matte is configured for placement between said selected image and said selected frame; and
displaying said frame, said selected image, and said selected matte in their selected sizes on said viewing surface.

14. The method according to claim 11, wherein said attribute displaying step further comprises the steps of:
displaying mounting background options, wherein said mounting background options include mounting background color and dimensions; and
displaying said selected image and said selected mounting background in their selected dimensions and colors on said viewing surface.

15. The method according to claim 14, wherein said attribute displaying step further comprises the steps of:
displaying mounting position options, wherein said mounting position options include mounting positions for said selected image on said selected mounting background; and
displaying said selected image according to said selected mounting position on said mounting background on said viewing surface.

16. The method according to claim 11, further comprising the step of:
displaying decorator information according to said selected image.

17. A business method for supplying printed versions of selected images, comprising the steps of:
supplying a customer with a plurality of images to choose from;
supplying said customer with a plurality of attribute options for any chosen image, including the dimensions of the chosen image;
displaying said chosen image with its selected attributes; and
printing said chosen image according to its chosen dimensions.

18. The business method according to claim 17, wherein said printing step further comprises printing said chosen image on a print medium having at least an A3 size on a large format printer.

19. The business method according to claim 17, wherein said attribute options supplying step comprises the further steps of:
supplying said customer with a plurality of frames and a plurality of frame dimensions to choose from; and
displaying said selected frame and said chosen image in their selected dimensions.

20. The business method according to claim 19, wherein said attribute options supplying step comprises the further steps of:
supplying said customer with a plurality of matte colors and dimensions to choose from; and
displaying said selected frame, said chosen image, and said selected matte in their selected dimensions.

21. The business method according to claim 17, wherein said attribute options supplying step comprises the further steps of:
supplying said customer with a plurality of mounting background colors and dimensions to choose from; and
displaying said chosen image and said selected mounting background in their selected dimensions and colors.

22. The business method according to claim 21, wherein said attribute options supplying step comprises the further steps of:
supplying said customer with a plurality of mounting positions for said chosen image on said selected mounting background; and
displaying said chosen image in said selected mounting position on said mounting background.

23. The business method according to claim 17, further comprising the step of:
supplying said customer with decorator information according to selected ones of said attribute options.
